(19) United States
(12) Patent Application Publication
(10) Pub. No.: US 2024/0014022 A1
(43) Pub. Date: Jan. 11, 2024

(54) APPARATUS AND METHOD

(71) Applicant: ISOTOPX LTD, MIDDLEWICH CHESHIRE (GB)

(72) Inventors: Damian Paul TOOTELL, MIDDLEWICH CHESHIRE (GB); Anthony Michael JONES, MIDDLEWICH CHESHIRE (GB)

(21) Appl. No.: 18/255,837

(22) PCT Filed: Dec. 3, 2021
(86) PCT No.: PCT/GB2021/053174

§ 371 Date: Jun. 2, 2023

(30) Foreign Application Priority Data
Dec. 3, 2020 (GB) 2019057.5

(51) Int. Cl. H01J 49/02; H01J 49/04; H01J 49/28

(52) U.S. Cl. CPC H01J 49/022; H01J 49/0422; H01J 49/28; H01J 49/08

(57) ABSTRACT

An ion source (30) for a static gas mass spectrometer is described. The ion source (30) comprises: a source block (310) defining a volume V to receive a sample gas G; an electron source (320) in fluid communication with the source block (310) and configured to provide a flux of electrons E therein for ionising the sample gas G; a set of electrodes (330), including a first electrode (330A), disposed between the electron source (320) and the source block (310); and a controller (not shown) configured to control a voltage applied to the first electrode (330A) to attenuate the flux of the electrons E into the source block (310) during a first time period following receiving of the sample gas G in the source block (310) and to permit the flux of the electrons E into the source block (310) during a second time period following the first time period.

### FIELD

The present invention relates to ion sources for static gas mass spectrometry.

### BACKGROUND TO THE INVENTION

FIG. 1 schematically depicts a conventional ion source for a static gas mass spectrometer. Static gas mass spectrometers are typically used for isotope ratio mass spectrometry.

Typically, in static gas mass spectrometry (also known as static vacuum mass spectrometry), a discrete gas sample is admitted into the mass spectrometer by opening of an inlet valve, allowing the gas sample to expand into the source block of the mass spectrometer, and the inlet valve subsequently closed. This moment in time, when the gas sample is admitted, may be referred to as ‘time-zero’ or t₀. From that moment in time, the partial pressure of the gas sample changes rapidly until a pressure equilibrium is reached within the vacuum envelope of the mass spectrometer. This equilibration process is mass dependent and may take a number of minutes. Mass spectrometry analysis is performed under static gas conditions, preferably after equilibration is complete. In contrast, gas chromatography (GC) mass spectrometry analysis is performed under dynamic gas conditions, using a continuously admitted gas sample. During static gas mass spectrometry, the ion source conditions are preferably maintained stable over time in order to avoid distortion of measured isotope ratios, for example. For example, changes in filament temperature during sample measurement would result in uncontrolled isotope fractionation and affect the accuracy and precision of the measurement. Changes in filament current during the measurement might influence the space charge conditions inside the ionization volume and thus affect the mass discrimination of the ion source. Furthermore, there is an initial equilibration time or period, starting from time zero until the different isotopes have evenly spatially dispersed throughout the volume of the mass spectrometer. Because of the increased viscosity, this equilibration time can last longest for the heavier noble gases such as Xenon, which can take several minutes (e.g. up to 10 minutes) before all isotopic species of the noble gas sample have been fully equilibrated from the sample prep line into the volume of the mass spectrometer. For example, equilibration can take about 3 minutes for argon, or 6 to 7 minutes for Xenon. The equilibration time will depend on characteristics of the particular mass spectrometer as well as of the gas sample.

The gas-source mass spectrometer includes an ion source 10 comprising a source block 110 within a wall 112 of which the electron input aperture 111 is formed adjacent a heated cathode 120 (which is external to the gas-source block). Electrons emitted by the heated cathode 120 at A are attracted towards the source block 110 by the potential difference (negative relative to the source) used to accelerate the thermionic electrons to a desired energy. The electron voltage potential is the potential difference (in volts) between the cathode 120 and the source block 110. Its role is two-fold: the direction of the potential field causes the electrons to accelerate towards the source block 110; while the magnitude of the potential provides sufficient energy to cause ionisation events.

The electrons pass through the electron input aperture 111 into the chamber or volume V of the source block 110 as an electron beam E for use in ionisation of the sample gas G injected therein (gas injection means not shown). Electrons from the electron beam E are collected on the opposite side, after passing through an electron output aperture 113 formed in a wall 114 of the source block 110 and opposing the electron input aperture 111. The electrons E are so collected by an electron trap unit 140 held at a positive voltage relative to the source block 110. This electron beam E traverses the chamber of the source block 110 along a beam axis which lies just behind the ion exit slit 115 so that ions I which are formed by the impact of electrons E on the neutral source-gas molecules G in region C can be efficiently drawn out of the chamber by the penetrating ‘extraction’ electric field created by Y focus plates (also known as extraction half plates) 160. The extracted ion beam I is directed to an output slit 170 formed in a plate to collimate the ion beam IB for onward manipulation/use within the mass spectrometer.

The ion extraction field is modified by the presence of an ion repeller plate 150 inside the source block 110. The ion repeller plate 150 is normally operated at a negative potential to ensure that the gas ions I are formed, by bombardment from the thermionic electrons of the electron beam E, in the region C of relatively low electric field gradient. The ionising electron beam E may be optionally constrained in its passage between the filament coil 120 and the electron trap 140 by the presence of two collimating magnets (not shown) which produce a field of over 200 Gauss parallel to the required electron beam axis. This magnetic field also serves to increase the path length of the electrons which increases the probability of impact with a gas atom/molecule, and its ionisation. The ions extracted from the ionisation region B pass between the Y-focus plates 160 and are brought to a focus in the region of the defining slit 170 (also known as source slit). The image formed is normally smaller than the width of the slit 170. This reduces mass discrimination in the source due to the presence of the magnetic field from the source magnets.

A detailed example of a static gas mass spectrometer employing such a source is described in U.S. Pat. No. 2,490,278 (A. O. O Nier) and also in the following paper, with reference to FIG. 2 therein: “A Mass Spectrometer for Isotope and Gas Analysis”: Alfred O. Nier. The Review of Scientific Instruments, Volume 16, Number 6, page 398, June 1947.

Hence, in summary, in normal operating conditions, such a Nier-type source employs an electron source (cathode) held at a negative voltage (A) relative to the source block. The magnitude of this voltage needs to be sufficiently high to cause ionisation of atoms or molecules of the sample gas. That is, the electron energy, due to acceleration of the electrons by the voltage, needs to be sufficiently high to cause ionisation of atoms or molecules of the sample gas. This causes an electron current (blue region) to traverse the source block and be measured on the trap plate. Ionisation can occur at any point along the blue region of the electron beam. If ionisation occurs in the extraction region C, then those ions are accelerated out of the source block, for example towards a detector via a mass separator.

As the partial pressure equilibrates, the detected ion beam signal, due to ionisation of the gas sample, stabilises, at which time data may be collected. The process of ionisation of the gas sample, the subsequent extraction of the ions from the source block and acceleration of the ions into the mass analyser also has the undesired effect that a portion of these ions are implanted and ‘consumed’, such that an intensity of the detected ion beam signal decreases with time. This process also mass fractionates the gas sample so it is typically necessary to correct the data to provide information about the partial pressure of an isotope of interest at ‘time-zero’ or t₀, at which the gas sample was first exposed to these undesirable mass fractionation effects.

FIG. 2A shows the intensity of the detected ion beam signal for an isotope of interest, from ‘time-zero’ or t₀ (i.e. time=0 seconds in this example). The intensity initially increases to a peak as the sample gas enters the source block and then decreases during a first time period (about 60 seconds) following receiving of the sample gas in the source block during equilibration and then more slowly decreases until it reaches stability corresponding to the gas sample having attained equilibrium in the source block. Equilibrium is reached when partial pressures of the sample gas attain stasis i.e. when all the species of interest are uniformly distributed throughout the vacuum chamber and in particular, reach constant density in the source block. The ion source itself causes mass fractionation of the isotopes and therefore a change in isotope ratio with time. Space charge effects and the different kinetics of the lighter compared with the heavier isotopes result in slightly different transmission and ionization probabilities. Because of preferential ionization of different isotopes, the isotopic composition of the gas sample changes over time and, as such, the measured isotope ratio changes over time. In order to calculate the true isotopic composition of the gas sample, it is important to calculate the isotope ratio at the time of sample introduction.

FIG. 2B shows the intensity of the detected ion beam signal for the isotope of interest, after discarding data from the first time period. Particularly, to make use of the data, the initial portion of the data is discarded and a regression of the remaining data (starting at the point when equilibration is reached) is extrapolated back to ‘time-zero’ or t₀ which quantifies the unfractionated sample. However, such extrapolation increases uncertainty in the regression, thereby adversely affecting error in quantifying the isotope of interest, for example reducing a precision of isotope ratio calculations. In this example, the extrapolated intercept precision 0.92%.

Hence, there is a need to improve static gas mass spectrometry.

### SUMMARY OF THE INVENTION

It is one aim of the present invention, amongst others, to provide an ion source for a static gas mass spectrometer which at least partially obviates or mitigates at least some of the disadvantages of the prior art, whether identified herein or elsewhere. For instance, it is an aim of embodiments of the invention to provide an ion source for a static gas mass spectrometer that provides for improved accuracy and/or precision of isotope measurement.

A first aspect provides an ion source for a static gas mass spectrometer, the ion source comprising:
a source block defining a volume to receive a sample gas;
an electron source in fluid communication with the source block and configured to provide a flux of electrons therein for ionising the sample gas;
a set of electrodes, including a first electrode, disposed between the electron source and the source block; and
a controller configured to control a voltage applied to the first electrode to attenuate the flux of the electrons into the source block during a first time period following receiving of the sample gas in the source block and to permit the flux of the electrons into the source block during a second time period following the first time period.

A second aspect provides a static gas mass spectrometer comprising an ion source according to the first aspect.

A third aspect provides a method of controlling an ion source of a static gas mass spectrometer, the method comprising:
receiving, by a volume defined by a source block, a sample gas;
providing, by an electron source in fluid communication with the source block, a flux of electrons therein and ionising the sample gas;
controlling, by a controller, a voltage applied to a set of electrodes, including a first electrode, disposed between the electron source and the source block, comprising:
attenuating, during a first time period following receiving of the sample gas in the source block, the flux of the electrons into the source block; and
permitting, during a second time period following the first time period, the flux of the electrons into the source block.

A fourth aspect provides a method of controlling a static gas mass spectrometer, the method comprising:
controlling the ion source according to the third aspect; and
detecting, during the second time period following the first time period, the ions from the sample gas.

A fifth aspect provides a non-transient computer-readable storage medium comprising instructions which, when executed by a computer comprising a processor and a memory, cause the computer to perform a method according to the third aspect and/or the fourth aspect.

### DETAILED DESCRIPTION OF THE INVENTION

According to the present invention there is provided an ion source for a static gas mass spectrometer, as set forth in the appended claims. Also provided is a static gas mass spectrometer, a method of controlling an ion source for a static gas mass spectrometer, a method of controlling a static gas mass spectrometer and a non-transient computer-readable storage medium. Other features of the invention will be apparent from the dependent claims, and the description that follows.

Ion Source

The first aspect provides an ion source for a static gas mass spectrometer, the ion source comprising:
a source block defining a volume to receive a sample gas;
an electron source in fluid communication with the source block and configured to provide a flux of electrons therein for ionising the sample gas;
a set of electrodes, including a first electrode, disposed between the electron source and the source block; and
a controller configured to control a voltage applied to the first electrode to attenuate the flux of the electrons into the source block during a first time period following receiving of the sample gas in the source block and to permit the flux of the electrons into the source block during a second time period following the first time period.

In this way, by attenuating the flux of the electrons (i.e. the electron current) into the source block during the first time period following receiving of the sample gas in the source block, a rate of ionisation of the sample gas during the first time period following receiving of the sample gas in the source block is correspondingly lessened compared with non-attenuation. By lessening the rate of ionisation of the sample gas during the first time period following receiving of the sample gas in the source block, a rate of consumption and/or mass fractionation of the sample gas is accordingly lessened during the first time period following receiving of the sample gas in the source block. In this way, deleterious effects due to consumption and/or mass fractionation of the sample gas during equilibration thereof during the first time period following receiving of the sample gas in the source block are diminished, thereby reducing error in quantifying isotopes of interest, for example improving a precision of isotope ratio calculations.

In other words, the invention involves lowering the electron current into the source block, for example to zero, during an initial equilibration time of the sample gas in the mass spectrometer. The lowered electron current reduces or ensures that no sample gas is ionized during the initial sample equilibration phase. Once the initial equilibration phase is completed, the electron current is raised so that the sample gas is ionized. That is, the electron flux into the source block is interrupted during equilibration of the sample gas and subsequently, the electron flux into the source block is restored for analysis of the equilibrated gas.

It should be understood that the flux of the electrons is attenuated, rather than an energy of the electrons reduced. That is, the electron energy is maintained sufficiently high to cause ionisation of atoms or molecules of the sample gas but the electron current is sufficiently low to lessen the rate of ionisation of the sample gas. Modulation of the energy of the electrons so as to not cause ionisation of atoms or molecules of the sample gas would require a reduction in an accelerating voltage of the electrons which may in turn result in a change in temperature of a filament of the electron source. In more detail, a change in electron energy may have a temperature-changing effect on the filament. If the electron energy were to be decreased, for example during the first period of time, acceleration of the electrons away from the filament would be reduced and the filament temperature would increase. Increasing the filament temperature would increase electron emission and hence the flux of electrons. If the electron energy were subsequently increased, for example during the second time period, the increased filament temperature arising from heating during the first time period, would result in an increased electron current of electrons having sufficiently high energy and hence an increased ionisation rate of the sample gas. However, as the filament temperature subsequently cools, due to the now increased acceleration of the electrons away from the filament during the second time period, the electron current falls and hence the ionisation rate of the sample gas also falls. That is, the ionisation rate of the sample gas is susceptible to changes in the filament temperature arising from modulation of the energy of the electrons. In order to compensate for this change in filament temperature, the filament heating current may be adjusted to maintain a substantially constant filament temperature and therefore ion source temperature. Hence, modulation of the electron energy requires regulation of the filament heating current so as to keep the filament temperature substantially the same during the first time period and the second time period, thereby increasing complexity while heating or cooling of the filament will adversely affect an accuracy and/or a precision of quantification.

Ion Source

The first aspect provides the ion source. In one example, the ion source comprises and/or is a Nier, Bernas, Nielsen, Freeman or Cusp-type source or a hybrid thereof, for example a Nier-Bernas-type source. In one preferred example, the ion source comprises and/or is a Nier-type source. Generally, a Nier-type source ionizes atoms or molecules of the sample gas by producing the flux of the electrons perpendicular to the path of the ion beam. The source block is held at a high voltage (typically 3000-5000 V).

Static Gas Mass Spectrometer

It should be understood that the ion source is suitable for a static gas mass spectrometer. More generally, the ion source may be suitable for mass spectrometers, optical emission spectrometers, particle accelerators, ion implanters and/or ion engines.

Source Block

The ion source comprises the source block (also known as a gas-source chamber, an ionizing chamber or an ion box) defining the volume to receive the sample gas. Source blocks are known.

In one example, the source block comprises an electron inlet aperture or passageway provided in a wall thereof for the electron flux and optionally, an electron outlet aperture or passageway provided in an opposed wall thereof.

In one example, the source block comprises an ion outlet aperture or slit, for example provided in a wall transverse to the electron inlet aperture and/or electron outlet aperture.

In one example, the source block comprises an ion repeller plate, typically operated at a negative potential to ensure that the ions are formed by bombardment by the electron flux, in a region of relatively low electric field gradient.

Trap

In one example, the ion source comprises a trap (also known as electron trap) for collecting the electron flux exiting the source block, for example via an electron outlet aperture or passageway provided in a wall thereof.

In one example, the controller is configured to control the electron source according to the electron flux or trap current received by the trap to stabilise the electron flux, for example by feedback or closed-loop control of the electron source. It should be understood that stabilising the electron flux relates to operating the electron source in a stable region of electron emission, providing a substantially electron flux as a function of temperature of the electron source.

Extraction Half Plates

In one example, the ion source comprises Y focus plates (also known as extraction half plates) for extracting the ions from the volume of the source block, for example via an ion outlet aperture thereof.

Collimating Magnets

In one example, the ion source comprises collimating magnets for constraining a path of the electron flux.

Source Slit

In one example, the ion source comprises a defining slit (also known as source slit).

Sample Gas

In one example, the sample gas comprises and/or is a noble gas for example He, Ne, Ar, Kr, Xe, Rn, preferably Ar, Kr, Xe, which have significant equilibration times.

Electron Source

The ion source comprises the electron source in fluid communication with the source block and configured to provide the flux of electrons therein (i.e. in the source block, particularly in the volume thereof) for ionising the sample gas.

That is, ionising of atoms or molecules of the sample gas is by electron beam bombardment. The flux of electrons may be known as a trap current.

In one example, the electron source comprises and/or is a thermionic electron emitter. Typically, electrons are generated by thermionic emission from a cathode (i.e. the thermionic electron emitter), accelerated through the volume containing the gas molecules and collisions between the accelerated electrons and the atoms or molecules of the sample gas ionise a proportion thereof.

In one example, the thermionic electron emitter comprises a tungsten filament, for example a ribbon or a coiled wire, providing a cathode, wherein the electrons are emitted from an electron emitter surface thereof by passing an electrical heating current therethrough.

In one example, the electron source comprises an electron emitter cathode presenting a thermionic electron emitter surface and a heater element electrically isolated from the electron emitter cathode and arranged to be heated by an electrical current therein and to radiate heat to the electron emitter cathode sufficient to liberate electrons thermionically from said electron emitter surface. In this way, it is not necessary to pass an electrical heating current through the electron emitter surface. Instead, an electrical heating current is passed through a separate heating element which becomes heated to sufficient temperature e.g. incandescent hot, to radiate heat electromagnetically to the electron emitter cathode which is positioned adjacent to the heating element in order that it may absorb radiated heat energy and be heated remotely. By removing the need to apply a voltage across a directly electrically heated electron emitter coil, problems associated with a potential gradient applied thereto and the resulting variation in emitted electron energy are avoided. This provides a more homogeneous electron energy which will provide greater control of the conditions affecting ionisation probability within the ion source, compared with a tungsten filament, for example.

The separation of the electrical heating aspect and the electron emission aspect of the electron source, enables the use of more optimal materials for thermionic electron emission which would not be suitable for heating electrically. Indeed, it has been found that electron emissions are increased by a factor of up to 5 to 10, as compared to electron emission rates from existing electrically heated electron sources operating over a comparable operation lifetime. Thus, whereas it is possible to increase electron emission rates from existing electrically heated electron sources, the great cost is that the electrically heated source will “burn out” very quickly. It will then need replacement within the mass spectrometer which will require a spectrometer to be opened up (vacuum lost) potentially causing months of down-time. High electron emission rates have been found to be achievable, according to the invention as compared to existing systems, at significantly lower operating temperatures. This has a significant practical consequence because the reduced temperature reduces the presence of hydrocarbon volatiles within the vacuum of the mass spectrometer in use. For example, a flow rate of electrons into, or across, the gas chamber may exceed 500 μA, or preferably may exceed 750 μA, or more preferably may exceed 1 mA, or yet more preferably may exceed 2 mA, during the second time period. For example, an electron flow rate may be between 500 μA and 1 mA, or may be between 1 mA and 20 mA, or as described below, during the second time period. These electron flow rates may be achievable when the temperature of the electron emitter cathode is preferably less than 2000° C., or more preferably less than 1500° C., or yet more preferably less than 1250° C., or even more preferably less than 1000° C., such as between 750° C. and 1000° C. For example, the gas-source mass spectrometer may comprise an electron trap operable to receive electrons from the electron emitter cathode which have traversed the gas-source chamber as a current of at least 50 μA in response to the electron emitter cathode being heated by the heater element to a temperature not exceeding 2000° C.

In one example, the electron emitter cathode is selected from: an oxide cathode; an I-cathode or Ba-dispenser cathode. In one example, the electron emitter cathode comprises a base part bearing a coating of thermionically emissive material presenting the electron emitter surface. When the electron emitter cathode comprises a base part bearing a coating, the coating may comprise a material selected from: an alkaline earth oxide; Osmium (Os); Ruthenium (Ru). The work function of the electron emitter surface, at a given temperature, may be reduced by the presence of the coating. For example, the coating material may provide a work function less than 1.9 eV at a temperature not exceeding 1000° C. When no coating is used, the work function of the electron emitter surface may be greater than 1.9 eV at a temperature not exceeding 1000° C. Many other types of possible emitter material (e.g. Tungsten, W; Yttrium Oxide, e.g. Y₂O₃; Tantalum, Ta; Lanthanum/Boron compounds, e.g. LaBs) are available.

In one example, the base part comprises Tungsten or Nickel. In one example, the base part comprises a metallic material which separates the coating from the heater element.

Oxide cathodes are generally cheaper to produce. They may, for example, comprise a spray coating comprising (Ba,Sr,Ca)-carbonate particles or (Ba,Sr)-carbonate particles on a nickel cathode base part. This results in a relatively porous structure having about 75% porosity. The spray coating may include a dopant such as a rare earth oxide e.g. Europia or Yttria. These oxide cathodes offer good performance. However other types of cathode may be employed which may be more robust to being exposed to the atmosphere (e.g. when the mass spectrometer is opened).

So-called ‘I-cathodes’ or ‘6a-dispenser’ may comprise a cathode base consisting of porous tungsten, e.g. with about 20% porosity, impregnated with a Barium compound. The base part may comprise tungsten impregnated with a compound comprising Barium Oxide (BaO). For example, the Tungsten may be impregnated with 4BaO·CaO·Al₂O₃, or other suitable material. In one example, the electron source comprises a sleeve surrounding the heater element, wherein the electron emitter surface resides proximal or at an end of the sleeve.

In one example, the heater element comprises a metallic filament coated with a coating comprising a metal oxide material.

Due to the improved rate of emission of electrons from the electron emitter cathode, for a given temperature of the heater element, it has been found that ample electron emission rates can be achieved at lower electrical input power levels as compared to existing electron emitter systems employing electrically heated electron emitter services/materials. For example, the electron emitter cathode may be operable to be heated by the heater element to a temperature not exceeding 2000° C. when the electrical power input to the heater element does not exceed 5 W. Preferably the electrical input power does not exceed 4 W, or more preferably does not exceed 3 W, yet more preferably does not exceed 2 W, or even more preferably does not exceed 1 W. The electrical power input to the heater element may be between about 0.5 W and about 1 W. These lower power input ratings enable the electron source to last longer, due to lower rates of cathode deterioration, and permit operation at lower temperatures with all of the attendant advantages flow from that. The lower rates of cathode deterioration provide improved uniformity of electron output improving consistency of the electron source. For example, the relatively high rates of deterioration in existing electron emitter cathodes, heated electrically, result in inconsistent cathode performance and mechanical instability as the cathode physically loses material (“burns out”) in use which often causes it to progressively change shape, especially in response to being heated, which has the effect of changing the electron output performance. These problems are significantly reduced according to the present invention.

In one example, the electron source comprises and/or is a field emission gun (FEG), such as a cold-cathode type, usually made of single crystal tungsten sharpened to a tip radius of about 100 nm, or a Schottky type. FEGs are also known as cold Field Electron Emitters and use large field gradients to generate free electrons without a heater. FEGs eliminate the need to stabilise temperature of a thermionic electron emitter.

The gas-source chamber may be arranged to receive electrons from the electron emitter cathode at an electron input opening shaped to form an electron beam within the gas-source chamber which is directed towards the electron trap without the use of a collimator magnet.

This is because of the significantly higher electron flow rates achievable according to the invention. Collimation using collimator magnets, to increase electron beam intensity (i.e. rate of flow per unit area transverse to the beam), has been found to be no longer necessary, although embodiments of the invention may include collimator magnets if desired. Ample electron beam intensity is achievable due to the enhanced electron flow rates, according to the invention.

In one example, the electron source is in fluid communication with the source block via an aperture or passageway provided in a wall thereof.

Electrode

The ion source comprises the first electrode disposed between the electron source and the source block.

In one example, the first electrode comprises and/or is a cathode configured to decelerate the electrons theretowards and/or repel the electrons therefrom, for example during the first time period. That is, the cathode reduces an energy of the electrons and/or repels the electrons, so as to attenuate the flux of electrons into the source block during the first time period. In one example, the cathode is disposed axially with respect to the flux of electrons into the source block and is arranged to interrupt the flux of electrons into the source block (i.e. in the path of the flux of electrons and thus perforated to allow transmission of electrons therethrough during the second time period). For example, the cathode may comprise a grid, as described below. In one example, the cathode is disposed off axis with respect to the flux of electrons into the source block and is arranged to deflect the flux of electrons away from the source block (i.e. not in the path of the electrons and acts as a transverse repeller).

In one example, the first electrode comprises and/or is a grid configured to interrupt the flux of electrons into the source block, as described below. Particularly, by using a grid, the flux of the electrons is not dependent on a temperature of a thermionic electron emitter of the electron source. Hence, changes in temperature thereof do not affect the flux of the electrons, for example during the first time period or the second time period.

In one example, the first electrode comprises and/or is one or more electron extraction grids and the controller is configured to control the voltage applied to the first electrode to attenuate the flux of the electrons into the source block during the first time period following receiving of the sample gas in the source block by applying a negative voltage to the first electrode and to permit the flux of the electrons into the source block during the second time period following the first time period by applying a positive voltage to the first electrode. That is, during the first time period, the first electrode behaves as a cathode repelling the electrons therefrom while during the second time period, the first electrode behaves as an anode accelerating the electrons theretowards and/or therethrough. It should be understood that the one or more grids are permeable to the electrons from the electron source, for example being preferably reticulated or porous or otherwise provided with through-holes arranged in communication with the electron source such that electrons attracted to the one or more grids are permitted to pass the through from a side thereof facing the electron source to a side thereof facing the source block.

In one example, the first electrode comprises and/or is an anode configured to accelerate the electrons theretowards and/or attract the electrons theretowards, for example during the first time period or during the second time period. That is, the anode attracts the electrons away from the source block. In one example, the anode is disposed off axis with respect to the flux of electrons into the source block and is arranged to attract the flux of electrons away from the source block.

In one example, the first electrode comprises and/or is a deflector configured to deflect the flux of electrons away from the source block. In this way, the flux of electrons emitted by the ion source may be constant during the first time period and the second time period while deflected during the former, thereby maintaining constant (i.e. stable) conditions of the electron source. In this way, the filament temperature is maintained constant, or relatively more constant, compared with changing the electron energy, for example, as described previously. Particularly, the ion source conditions are preferably maintained stable over time in order to avoid distortion of measured isotope ratios, for example. For example, changes in filament temperature during sample measurement would result in uncontrolled isotope fractionation and affect the accuracy and precision of the measurement. Changes in filament current during the measurement might influence the space charge conditions inside the ionization volume and thus affect the mass discrimination of the ion source.

Controller

The ion source comprises the controller configured to control the voltage applied to the first electrode to attenuate the flux of the electrons into the source block during the first time period following receiving of the sample gas in the source block and to permit the flux of the electrons into the source block during the second time period following the first time period.

In one example, the attenuated flux of the electrons in the source block (also known as the trap current) during the first time period is in a range from 1 nA to 50 μA, preferably in a range from 10 nA to 10 μA, more preferably in a range from 50 nA to 5 μA, most preferably in a range from 0.1 μA to 1 μA.

In one example, the flux of the electrons in the source block (also known as the trap current) during the second time period is in a range from 50 μA to 20 mA, preferably in a range from 500 μA to 15 mA, more preferably in a range from 1 mA to 10 mA, most preferably in a range from 2 mA to 7.5 mA. In one example, the flux of the electrons in the source block during the second time period is in a range from 1 mA to 20 mA, preferably in a range from 2 mA to 17.5 mA, more preferably in a range from 2.5 mA to 15 mA, most preferably in a range from 5 mA to 10 mA.

In one example, the controller is configured to control the voltage applied to the first electrode to entirely attenuate (i.e. prevent) the flux of the electrons into the source block during the first time period

In one example, the controller is configured to control the flux of the electrons provided by the electron source. That is, the controller may be configured to control the electron current.

In one example, the controller is configured to determine the first time period, for example as described below.

In one example, the first time period is predetermined. For example, a test sample may be used to establish the equilibration time and hence a ‘blanking period’, which is used by the controller as the first time period for subsequent samples.

In one example, the first time period is calculated, for example by the controller. Conditions in the static gas mass spectrometer are known and the first time period may be calculated by the controller based on characteristics of the sample gas and vacuum envelope of the static gas mass spectrometer.

In one example, the first time period is measured by intermittent sampling, for example by selectively attenuating the flux of the electrons into the source block during the first time period so as to permit the flux of the electrons intermittently, for example periodically, into the source block during the first time period. For example, fast operation of the first electrode-regulated electron beam could be switched on for 100 ms every 10 seconds, providing intermittent sampling while consuming only nominally 1% of the sample gas compared with conventional operation. In this way, the first time period may be determined, for example dynamically, for the particular gas sample, rather than using a calculated or predetermined first time period.

In one example, the controller is configured to control the voltage applied to the first electrode to selectively attenuate the flux of the electrons into the source block during the first time period. In this way, a degree of attenuation and/or a duty cycle of attenuation may be controlled.

In one example, the controller is configured to control the voltage applied to the first electrode to permit the flux of the electrons, for example intermittently, into the source block during the first time period. In this way, ions may be intermittently detected, for example so as to measure the first time period.

In one example, a ratio of the flux of the electrons into the source block during the first time period to the flux of the electrons into the source block during the second time period is at most 1:10, preferably at most 1:25, more preferably at most 1:50, even more preferably at most 1:100, most preferably at most 1:1,000. For example, the flux of the electrons may be switched on for 100 ms per second (i.e. 1:10), 15 seconds per minute (i.e. 1:25), 2 ms per 100 ms (i.e. 1:50), 100 ms per 10 seconds (i.e. 1:100), or 10 ms per 10 seconds (i.e. 1:1,000). In this way, ions may be intermittently detected while consumption of the sample gas reduced.

Electron Source Temperature

In one example, the electron source comprises and/or is a thermionic electron emitter and the controller is configured to control a temperature of the thermionic electron emitter.

In one example, a temperature monitor, such as a pyrometer, is configured to measure a temperature of the thermionic electron emitter, for example a thermionic electron emitting source thereof, and to provide a feedback signal to the controller to control a heating current (for example via a controller) so as to maintain a substantially constant temperature throughout, i.e. during the first time period and the second time period.

In one example, a temperature change, for example a temperature rise, of the thermionic electron emitter is predetermined and the controller is configured to compensate for the temperature change by controlling, for example reducing, the heating current by a corresponding, for example calibrated, amount during the first time period and restoring the heating current during the second time period. For example, if attenuating the flux of the electrons causes a significant increase in temperature of the thermionic electron emitter, the heating current may be reduced by a small percentage during equilibration, returning it to normal level a few seconds before electrons are required. In the extreme, this could mean turning off the filament completely, the cathode has relatively small mass so it could be turned on again (say) five seconds before time-zero and even if it is still stabilising, the grid will quickly establish and stabilise the electron current.

In one example, the electron emitter is turned off at least initially during the first time period. In one example, the electron emitter is turned on during the first time period at a predetermined time before the start of the second time period. For example, if it is known how long it takes for the filament, for example, to heat up, the filament may be turned on again at a set time before analysis starts.

Electron Energy

In one example, the controller is configured to control an energy of the electrons provided by the electron source. In this way, the energy of the electrons may be controlled according to an ionisation potential of atoms or molecules of the gas sample. For example, the energy of the electrons may be controlled to be at least the ionisation potential of the atoms or molecules of the gas sample, thereby causing ionisation thereof. Conversely, the energy of the electrons may be controlled to be below the ionisation potential of the atoms or molecules of the gas sample, such that ionisation does not occur. For reference, the ionisation potentials of the noble gases are: He (24.6 eV), Ne (21.6 eV), Ar (15.8 eV), Kr (14 eV) and Xe (12.1 eV). In one example, the energy of the electrons is at least 10 eV, preferably at least 20 eV, more preferably at least 30 eV, most preferably at least 40 eV greater than the ionisation potential of the sample gas.

In one example, the first electrode comprises and/or is one or more electron extraction grids and the controller is configured to control the voltage applied to the first electrode to attenuate the flux of the electrons into the source block during the first time period following receiving of the sample gas in the source block by applying a negative voltage to the first electrode and to permit the flux of the electrons into the source block during the second time period following the first time period by applying a positive voltage to the first electrode. That is, during the first time period, the first electrode behaves as a cathode repelling the electrons therefrom while during the second time period, the first electrode behaves as an anode accelerating the electrons theretowards and/or therethrough. It should be understood that the one or more grids are permeable to the electrons from the electron source, for example being preferably reticulated or porous or otherwise provided with through-holes arranged in communication with the electron source such that electrons attracted to the one or more grids are permitted to pass the through from a side thereof facing the electron source to a side thereof facing the source block.

In one example, the set of electrodes includes a second electrode, for example an anode, disposed between the electron source and the source block, for example between the first electrode and the source block, in tandem (i.e. ion optically aligned with) with the first electrode. In one example, the controller is configured to apply a variable electrical potential to the second electrode for accelerating electrons emitted from the electron source in a direction towards the source block. In this way, the electron energy may be controlled and/or the electrons passing through the first electrode, wherein the first electrode comprises and/or is one or more electron extraction grids, may be accelerated theretowards.

In one example, the controller is configured to control the energy of thermionic electrons for input to the source block during the second time period by controlling the accelerating voltage(s) applied to the set of electrodes, for example the first electrode and/or the second electrode.

Electron Focusing

In one example, the set of electrodes includes a third electrode, for example one or more electron focusing electrodes, disposed between the electron source and the source block, in tandem with the first electrode and/or the second electrode. In one example, the third electrode comprises and/or is an Einzel lens for example, or other ion-optical lens arrangement, arranged to focus the electrons from the electron source into the source block via an aperture.

First Time Period

It should be understood that the first time period corresponds with the equilibration time, as described previously. The first time period starts with receiving of the sample gas in the source block and ends with equilibration of the sample gas in the source block.

The first time period is preferably a period of time that allows isotopes of the sample gas to equilibrate (i.e. reach equilibrium) in the mass spectrometer. It should be understood that equilibration refers to the spatial (geometrical) equilibration of the sample gas isotopes within the vacuum space of the mass spectrometer. The equilibration time depends on the type of gas, in particular due to its viscosity: heavier gases tend to have higher viscosities than lighter gases and consequently longer equilibration times.

Second Time Period

It should be understood that the second time period corresponds with the analysis time, as understood by the skilled person. The second time period starts with the end of the first time period.

Static Gas Mass Spectrometer

A second aspect provides a static gas mass spectrometer comprising an ion source according to the first aspect.

The static gas mass spectrometer may be as described with respect to the first aspect.

Method of Controlling an Ion Source

The third aspect provides a method of controlling an ion source of a static gas mass spectrometer, the method comprising:
receiving, by a volume defined by a source block, a sample gas;
providing, by an electron source in fluid communication with the source block, a flux of electrons therein and ionising the sample gas;
controlling, by a controller, a voltage applied to a set of electrodes, including a first electrode, disposed between the electron source and the source block, comprising:
attenuating, during a first time period following receiving of the sample gas in the source block, the flux of the electrons into the source block; and
permitting, during a second time period following the first time period, the flux of the electrons into the source block.

The ion source, the static gas mass spectrometer, the receiving, the volume, the source block, the sample gas, the electron source, the flux of electrons, the controlling, the controller, the voltage, the set of electrodes, the first electrode, the attenuating, the first time period, the permitting and/or the second time period media described with respect to the first aspect.

In one example, the method comprises:
equilibrating, during the first time period following receiving of the sample gas in the source block, the sample gas in the source block.

The equilibrating may be as described with respect to the first aspect.

In one example, the method comprises:
determining, by the controller, the first time period.

The determining may be as described with respect to the first aspect.

The method may include any steps as described with respect to the first aspect mutatis mutandis.

Method of Controlling a Static Gas Mass Spectrometer

The fourth aspect provides a method of controlling a static gas mass spectrometer, the method comprising:
controlling the ion source according to the third aspect; and detecting, during the second time period following the first time period, the ions from the sample gas.

In one example, the method comprises quantifying the ions, for example calculating an isotope ratio, during the second time period, for example only during the second time period.

The method may include any steps as described with respect to the first aspect, the second aspect and/or the third aspect mutatis mutandis.

CRM

The fifth aspect provides a non-transient computer-readable storage medium comprising instructions which, when executed by a computer comprising a processor and a memory, cause the computer to perform a method according to the third aspect and/or the fourth aspect.

### Definitions

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention, such as colourants, and the like.

The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and also may also be taken to include the meaning “consists of” or “consisting of”.

The optional features set out herein may be used either individually or in combination with each other where appropriate and particularly in the combinations as set out in the accompanying claims. The optional features for each aspect or exemplary embodiment of the invention, as set out herein are also applicable to all other aspects or exemplary embodiments of the invention, where appropriate. In other words, the skilled person reading this specification should consider the optional features for each aspect or exemplary embodiment of the invention as interchangeable and combinable between different aspects and exemplary embodiments.

### BRIEF DESCRIPTION OF THE DRAWINGS

For a better understanding of the invention, and to show how exemplary embodiments of the same may be brought into effect, reference will be made, by way of example only, to the accompanying diagrammatic Figures, in which:

FIG. 1 schematically depicts a conventional ion source, in use;

FIG. 2A shows the intensity of the detected ion beam signal for an isotope of interest, from ‘time-zero’ or t₀; and FIG. 2B shows the intensity of the detected ion beam signal for the isotope of interest, after discarding data from the first time period;

FIG. 3A schematically depicts an ion source according to an exemplary embodiment, in use; and FIG. 3B schematically depicts the ion source, in use;

FIG. 4 shows the intensity of the detected ion beam signal for an isotope of interest, from ‘time-zero’ or t₀;

FIG. 5A schematically depicts an electron source for an ion source according to an exemplary embodiment; and FIG. 5B schematically depicts an electron source for an ion source according to an exemplary embodiment;

FIG. 6 schematically depicts an ion source according to an exemplary embodiment;

FIG. 7 schematically depicts a method according to an exemplary embodiment; and

FIG. 8 schematically depicts a method according to an exemplary embodiment.

### DETAILED DESCRIPTION OF THE DRAWINGS

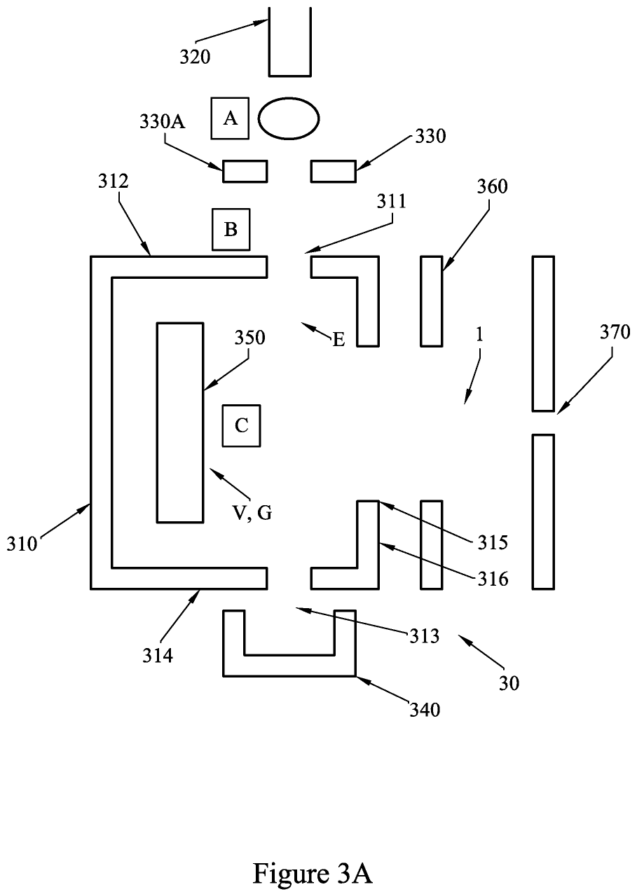

FIG. 3A schematically depicts an ion source 30 according to an exemplary embodiment, in use, particularly during the first time period; and FIG. 3B schematically depicts the ion source 30, in use, particularly during the second time period.

The ion source 30 is for a static gas mass spectrometer. The ion source 30 comprises:
a source block 310 defining a volume V to receive a sample gas G;
an electron source 320 in fluid communication with the source block 310 and configured to provide a flux of electrons E therein for ionising the sample gas G;
a set of electrodes 330, including a first electrode 330A, disposed between the electron source 320 and the source block 310; and
a controller (not shown) configured to control a voltage applied to the first electrode 330A to attenuate the flux of the electrons E into the source block 310 during a first time period following receiving of the sample gas G in the source block 310 and to permit the flux of the electrons E into the source block 310 during a second time period following the first time period.

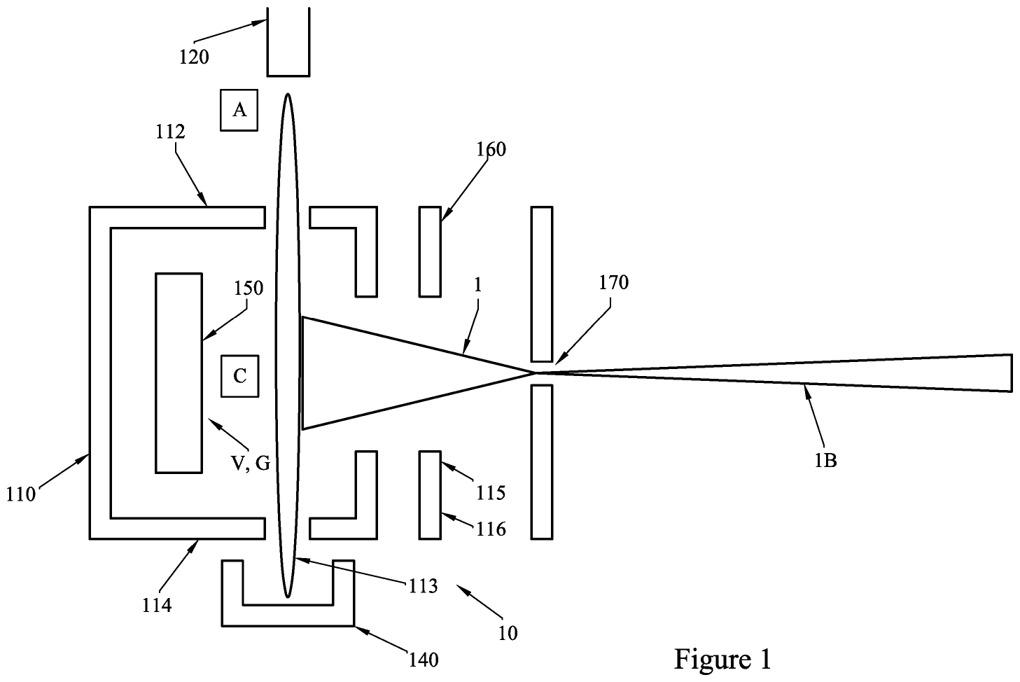

That is, in contrast to the conventional ion source 10 as described with respect to FIG. 1, the ion source 30 according to an exemplary embodiment further comprises the set of electrodes 330, including the first electrode 330A, disposed between the electron source 320 and the source block 310; and the controller configured to control the voltage applied to the first electrode 330A to attenuate the flux of the electrons E into the source block 310 during the first time period following receiving of the sample gas G in the source block 310 and to permit the flux of the electrons E into the source block 310 during the second time period following the first time period.

Typically, a static vacuum mass spectrometer has constant source conditions, so as soon as a sample is allowed into the mass spectrometer, then the extraction of ions and their consequent fractionation occurs.

The invention temporarily stops ionisation during the equilibration time period, then simultaneously restarts ionisation (a new time-zero is defined) and the data acquisition.

Hence, no fractionation or consumption of sample occurs during the inlet equilibration time period. Also, the regression of the data set need only be extrapolated back to the point at which the ion extraction was restarted i.e. after equilibration.

The invention incorporates the use of a grid electrode, for example, between the cathode and source block, whose voltage is controlled with an independent supply. In normal operation, this grid voltage is adjusted to provide the required trap current and ionisation.

However, to prevent extracted ions and sample fractionation during the equilibration period, the grid can be used to ‘turn off’ the electron beam, so that no ions are generated within the extraction region C.

Once the sample has equilibrated, the grid voltage can be restored to the normal operating condition (‘time-zero’) and the data analysis can begin immediately.

In summary, the grid electrode acts as a ‘tap’ and is used to stop the fractionation and consumption of the sample during the equilibration process, by preventing the formation of ions in the extraction region of the source. Once equilibration has occurred, then the grid voltage is restored to allow ionisation as before and simultaneously, the data acquisition can start.

In this example, the ion source 30 is a Nier-type source.

In this example, the source block 310 is generally as described with respect to the source block 110. Like reference signs denote like features.

In this example, the source block 310 comprises an electron inlet aperture 311 provided in a wall 312 thereof for the electron flux and an electron outlet aperture 313 provided in an opposed wall 314 thereof. In this example, the source block 310 comprises an ion outlet aperture 315, provided in a wall 316 transverse to the electron inlet aperture 311 and the electron outlet aperture 313. In this example, the source block 310 comprises an ion repeller plate 350. In this example, the ion source 310 comprises a trap 340 for collecting the electron flux exiting the source block 310, via the electron outlet aperture 313 provided in the wall 314 thereof. In this example, the ion source 30 comprises Y focus plates 360 (also known as extraction half plates) for extracting the ions from the volume V of the source block 310, for example via the ion outlet aperture 315 thereof. In this example, the ion source 30 comprises a defining slit 370 (also known as source slit).

In this example, the electron source 320 comprises a thermionic electron emitter. In this example, the electron source 320 comprises an electron emitter cathode presenting a thermionic electron emitter surface and a heater element electrically isolated from the electron emitter cathode and arranged to be heated by an electrical current therein and to radiate heat to the electron emitter cathode sufficient to liberate electrons thermionically from said electron emitter surface.

In this example, the electron source 320 is in fluid communication with the source block 310 via an aperture or passageway 311 provided in a wall 312 thereof.

In this example, the first electrode 330A comprises and/or is a cathode configured to decelerate the electrons theretowards and/or repel the electrons therefrom, for example during the first time period. In this example, the cathode 330A is disposed axially with respect to the flux of electrons into the source block and is arranged to interrupt the flux of electrons into the source block.

In this example, the first electrode 330A comprises and/or is a grid configured to interrupt the flux of electrons into the source block, as described below.

In this example, the first electrode 330A comprises and/or is one or more electron extraction grids and the controller is configured to control the voltage applied to the first electrode to attenuate the flux of the electrons into the source block during the first time period following receiving of the sample gas in the source block by applying a negative voltage to the first electrode and to permit the flux of the electrons into the source block during the second time period following the first time period by applying a positive voltage to the first electrode.

In this example, the controller is configured to control the voltage applied to the first electrode 330A to entirely attenuate (i.e. prevent) the flux of the electrons E into the source block 310 during the first time period

In this example, the controller is configured to determine the first time period, for example as described below.

In this example, the first time period is measured by intermittent sampling, for example by selectively attenuating the flux of the electrons into the source block during the first time period so as to permit the flux of the electrons intermittently, for example periodically, into the source block during the first time period.

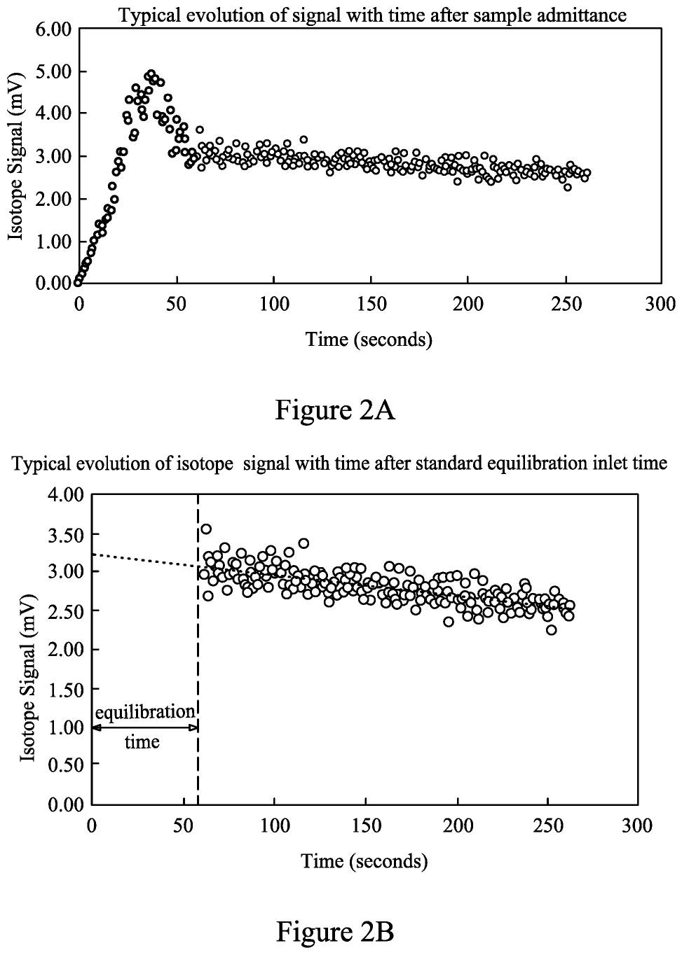

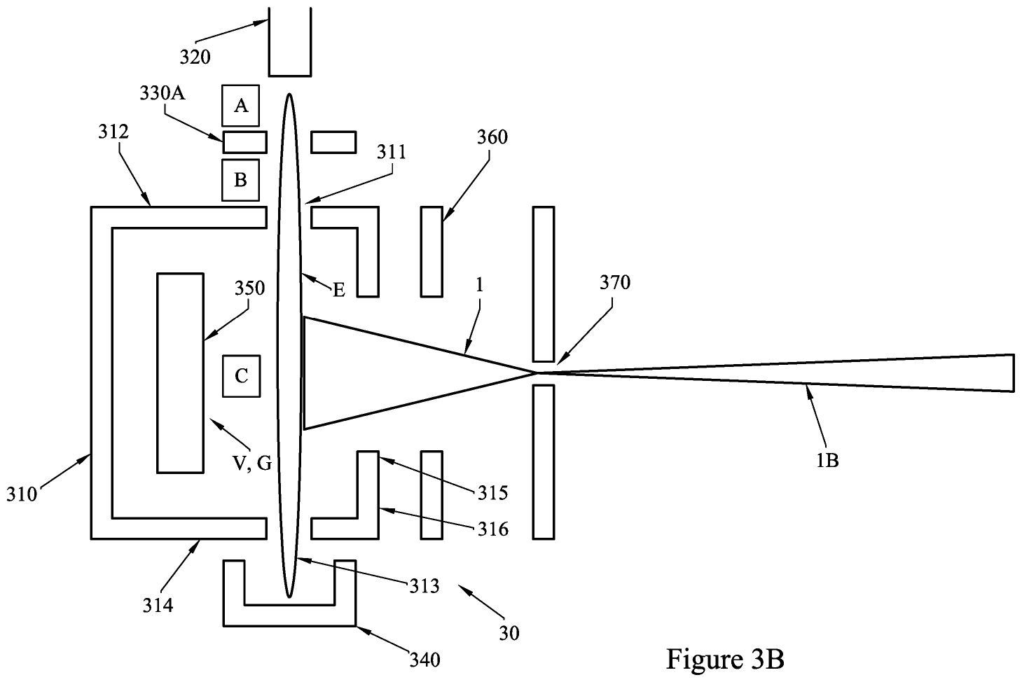

FIG. 4 shows the intensity of the detected ion beam signal for an isotope of interest, from ‘time-zero’ or t₀ (i.e. time=0 seconds in this example, corresponding with the start of the second time period). This example, the extrapolated intercept precision is 0.65% c.f. 0.92% for the conventional ion source of FIG. 2B.

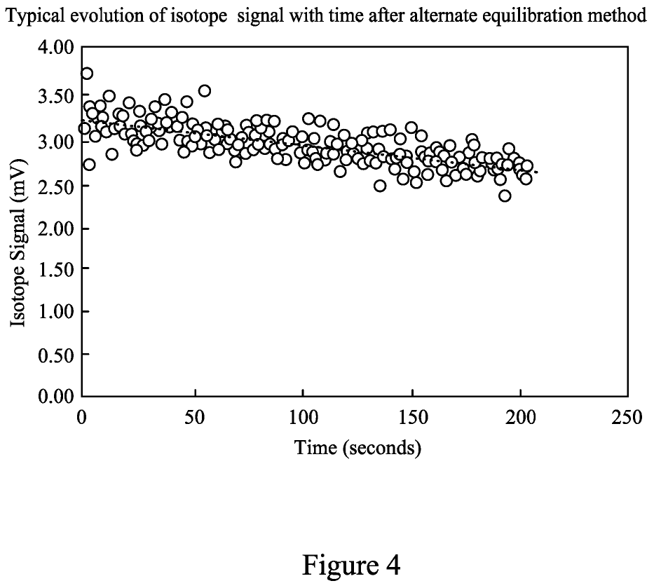

FIG. 5A schematically depicts an electron source 520A for an ion source according to an exemplary embodiment. The electron source comprises a tungsten wire filament coil 11 having opposite respective wire ends electrically connected to a current input terminal 12 having a first electrical potential, and a current output terminal 13 having a second electrical potential different to the first electrical potential thereby causing an electrical current to flow through the filament coil 11. Sufficient current flows to cause the tungsten filament coil to heat (e.g. incandescently) to a temperature sufficient to cause the surface of the filament coil to emit electrons thermionically from its surface. That is to say, the thermal energy acquired by the electrical heating effect of the electrical current passing though the filament coil is sufficient to imbue electrons in the filament coil to acquire an energy exceeding the surface work function of the filament coil. Although electrons are emitted generally omni-directionally from the filament coil 11, those electrons emitted in a preferred direction (D) are selected for input into a gas-source chamber of a gas-source mass spectrometer with which the filament coil 11 is in communication via an electron input slit 511A formed in a side wall of the source block 510A adjacent which the filament coil 11 is situated. A set of electrodes (not shown), including a first electrode (not shown), is disposed between the electron source 520A and the source block 510A.

FIG. 5B schematically depicts an electron source for an ion source according to an exemplary embodiment.

The cathode filament electron source 520B comprises a separated heater element 24 and cathode surface 26. The electron source includes an electron emitter cathode (25, 26) presenting a thermionic electron emitter surface 25 in communication with the source block of the gas-source mass spectrometer for providing electrons thereto. A heater element 24 is electrically isolated from the electron emitter cathode (25, 26) and arranged to be heated by an electrical current therein and to radiate heat to the electron emitter cathode sufficient to liberate electrons thermionically from the electron emitter surface. This provides the source of electrons for use in ionising a gas the gas-source chamber. A benefit of this arrangement is that the emitting surface is exposed to a more uniform acceleration potential resulting in a narrower energy spread of electrons. Consequently, most or all thermionic electrons reside at the same place, or region, within the accelerating electrical potential thereby improving the uniformity of thermionic electrons generated for use in ionising a target gas. An electrical heating current is not passed through the electron emitter surface 26. Instead, an electrical heating current is passed through a separate heating element 24 which becomes heated to sufficient temperature, to radiate heat electromagnetically (e.g. IR radiation) to the electron emitter cathode (25, 26). The cathode absorbs radiated heat energy and emit electrons thermionically in response to that. A flow rate of electrons across the gas chamber, in the electron beam, may exceed 500 μA or more. The flow rate of electrons across the gas chamber, in the electron beam, may be between 0.5 mA and 10 mA, e.g. 1 mA or several mA. These electron flow rates may be achievable when the temperature of the electron emitter cathode is less than 2000° C., e.g. about 1000° C. The electron emitter cathode (26, 25) is able to be heated by the heater element 24 to a temperature up to 2000° C. when the electrical power input to the heater element is less than 5 W. Indeed, typically, the electrical power input to the heater element 24 may be between about 0.5 W and about 1 W. The electron emitter cathode (26, 25) is an oxide cathode. In other embodiments an I-cathode (also known as a Ba-dispenser cathode) may be used. It comprises a Ni base part 25 which bears a coating of thermionically emissive material 26 presenting the electron emitter surface. The coating comprises (Ba,Sr,Ca)-carbonate particles or (Ba,Sr)-carbonate particles on a nickel cathode base part. The electron source 20 comprises a Nichrome sleeve 23 which surrounds the heater element 24. The electron emitter surface 26 and base part 25, collectively reside at an end of the sleeve. The base part 25 forms a cap enclosing tat end of the sleeve. The sleeve serves to concentrate heat from the heater element upon the base part 25, which conducts heat to the emitter coating 26. The heater element comprises a tungsten filament 21 coated with an alumina coating. This provides electrical isolation between the heating current within the heater element and the electron emitter cathode ((25, 26). This electron source offers greater electron emission at lower temperatures as compared to the tungsten filament. Typical operation requires 6.3V at 105 mA which is approximately 0.6 W of power. The local temperature on the cathode is then about 1000° C. This produces about 1 mA of electron trap current and a corresponding 5-fold sensitivity increase of the resulting ion beam produced by electron bombardment ionisation of a source gas via the electron beam 6. The lifetime of the cathode filament 20 is estimated to be more than 10 years, which far exceeds the ordinary operating lifetime of the tungsten coil filament 1, if it were to produce a comparable emission current. Benefits of using cathode as a replacement for the tungsten filament 1 include the following:
Higher electron emissions: by a factor of about 5-10 with a comparable lifetime to the existing tungsten filament 1. The tungsten filament coil 1 may produce similar emissions but the lifetime is considerably reduced before replacement is necessary. A filament replacement potentially causes months of down-time.
Lower operating temperatures: This reduces the presence of hydrocarbon volatiles in the vacuum which are ionised and interfere with the isotope species of interest.
The higher levels of emission: This means that the external magnetic field (magnets 14) can be removed. This avoids unwanted effects of this field on the mass analyser. Ion mass discrimination between isotopes is possible, as this tends to be non-linear over a given range of partial pressures of a sample/target material.
No voltage drop across the cathode: This cannot be avoided when using the tungsten filament coil 1. This provides a more homogenous electron energy which will provide greater control on sensitivity.
Mechanical stability: This improves the consistency of the electron source and the ion source which uses it, and avoids step changes in operation during cathode lifetime.
Extended lifetime: The lower operating temperature and conservative design of the cathode 20 results in extended useful life of the cathode coupled with low rates of filament deterioration.

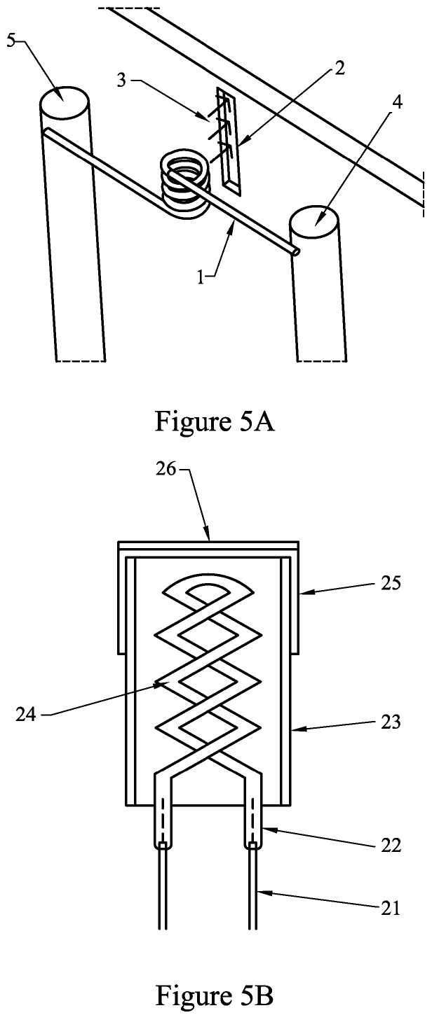

FIG. 6 schematically depicts an ion source 60 according to an exemplary embodiment. The ion source 60 is generally as described with respect to the ion source 30, description of which is not repeated for brevity and like reference signs indicate like all integers.

In this example, the first electrode 630A comprises and/or is one or more electron extraction grids and the controller is configured to control the voltage applied to the first electrode to attenuate the flux of the electrons into the source block during the first time period following receiving of the sample gas in the source block by applying a negative voltage to the first electrode and to permit the flux of the electrons into the source block during the second time period following the first time period by applying a positive voltage to the first electrode.

In this example, the set of electrodes 630 includes a second electrode 630B, an anode, disposed between the first electrode 630A and the source block 610, in tandem with the first electrode 630A. In this example, the controller is configured to apply a variable electrical potential to the second electrode 630B for accelerating electrons emitted from the electron source 620 in a direction towards the source block 610.

In this example, the set of electrodes 630 includes a third electrode 630C, disposed between the electron source 620 and the source block 610, in tandem with the first electrode 630A and the second electrode 630B. In this example, the third electrode 630C comprises an Einzel lens arranged to focus the electrons from the electron source 620 into the source block 610 via the aperture 611.

In this example, the controller is configured to control the energy of thermionic electrons for input to the source block 610 by controlling the accelerating voltage(s) applied to the anode 630B or applied to the extraction grid 630A, or both. This controllability is particularly effective and beneficial due to the relatively narrow spread in the distribution of kinetic energy amongst the thermionic electrons emitted from the electron source 610, as compared to the much broader corresponding distribution of kinetic energy amongst the thermionic electrons emitted from a conventional heated tungsten filament.

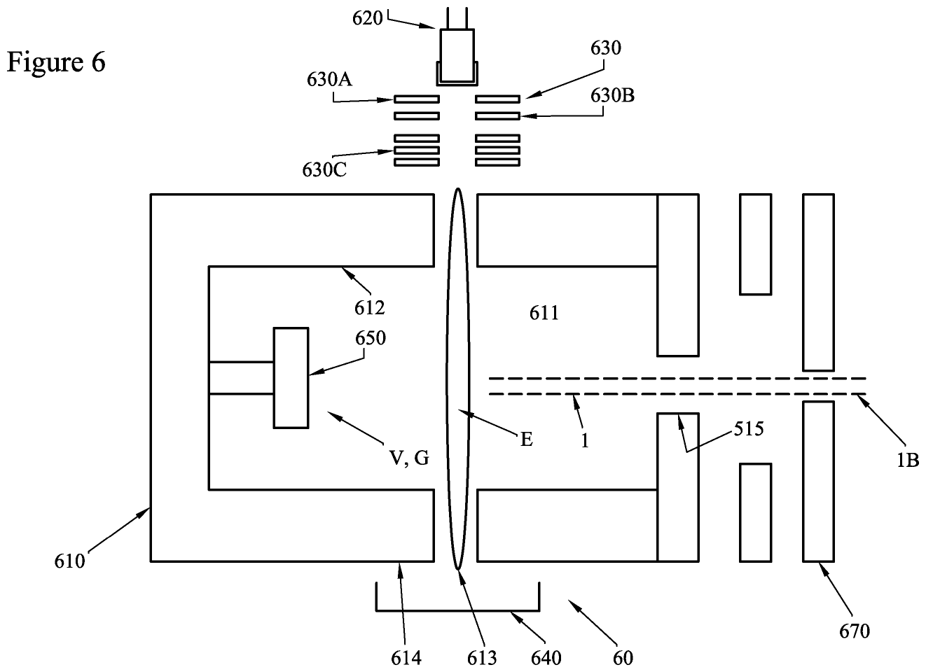

FIG. 7 schematically depicts a method according to an exemplary embodiment.

The method is of controlling an ion source of a static gas mass spectrometer.

At S701, the method comprises receiving, by a volume defined by a source block, a sample gas.

At S702, the method comprises providing, by an electron source in fluid communication with the source block, a flux of electrons therein and ionising the sample gas.

At S703, the method comprises controlling, by a controller, a voltage applied to a set of electrodes, including a first electrode, disposed between the electron source and the source block, comprising:
at S704, attenuating, during a first time period following receiving of the sample gas in the source block, the flux of the electrons into the source block; and
at S705, permitting, during a second time period following the first time period, the flux of the electrons into the source block.

The method may include any of the steps as described with respect to the third aspect.

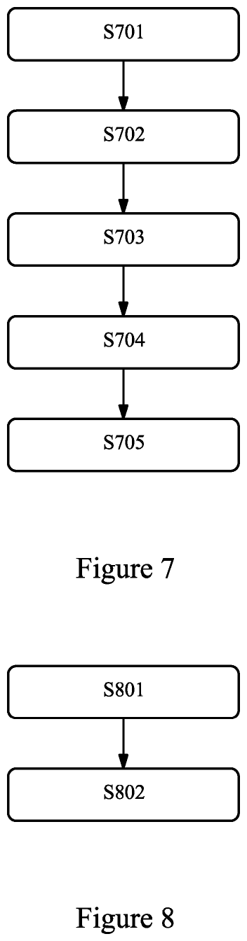

FIG. 8 schematically depicts a method according to an exemplary embodiment.

The method is of controlling a static gas mass spectrometer.

At S801, the method comprises the ion source as described with respect to FIG. 7.

At S802, the method comprises detecting, during the second time period following the first time period, the ions from the sample gas.

The method may include any of the steps as described with respect to the fourth aspect.

Although a preferred embodiment has been shown and described, it will be appreciated by those skilled in the art that various changes and modifications might be made without departing from the scope of the invention, as defined in the appended claims and as described above.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims and drawings), and/or all of the steps of any method or process so disclosed, may be combined in any combination, except combinations where at most some of such features and/or steps are mutually exclusive.

Each feature disclosed in this specification (including any accompanying claims, and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims and drawings), or to any novel one, or any novel combination, of the steps of any method or process so disclosed.

1. A static gas mass spectrometer comprising an ion source, the ion source comprising:
a source block defining a volume to receive a sample gas;
an electron source in fluid communication with the source block and configured to provide a flux of electrons therein for ionising the sample gas;
a set of electrodes, including a first electrode, disposed between the electron source and the source block; and
a controller configured to control a voltage applied to the first electrode to attenuate the flux of the electrons into the source block during a first time period following receiving of the sample gas in the source block and to permit the flux of the electrons into the source block during a second time period following the first time period;
wherein the first electrode comprises and/or is a deflector configured to deflect the flux of electrons away from the source block during the first time period.

2. The static gas mass spectrometer according to claim 1, wherein the first electrode comprises and/or is a cathode configured to decelerate the electrons theretowards and/or repel the electrons therefrom.

3. The static gas mass spectrometer according to claim 1, wherein the first electrode comprises and/or is an anode configured to accelerate the electrons theretowards and/or attract the electrons theretowards.

4. The static gas mass spectrometer according to claim 1, wherein the first electrode comprises and/or is a grid configured to interrupt the flux of electrons into the source block.

5. The static gas mass spectrometer according to claim 1, wherein the first electrode is disposed off axis with respect to the flux of electrons into the source block and is arranged to deflect the flux of electrons away from the source block.

6. The static gas mass spectrometer according to claim 1, wherein the controller is configured to control the flux of the electrons provided by the electron source.

7. The static gas mass spectrometer according to claim 1, wherein the electron source comprises and/or is a field emission gun or wherein the electron source comprises and/or is thermionic electron emitter and wherein the controller is configured to control a temperature of the thermionic electron emitter.

8. The static gas mass spectrometer according to claim 1, wherein the controller is configured to control an energy of the electrons provided by the electron source.

9. The static gas mass claim 1, wherein the controller is configured to control the voltage applied to the first electrode to selectively attenuate the flux of the electrons into the source block during the first time period.

10. The static gas mass spectrometer according to claim 9, wherein the controller is configured to control the voltage applied to the first electrode to permit the flux of the electrons into the source block during the first time period.

11. The static gas mass spectrometer claim 1, wherein a ratio of the flux of the electrons into the source block during the first time period to the flux of the electrons into the source block during the second time period is at most 1:100.

12. The static gas mass spectrometer claim 1, wherein the controller is configured to determine the first time period.

13. A static gas mass spectrometer, wherein the flux of electrons emitted by the ion source is constant during the first time period and the second time period.

14. A method of controlling an ion source of a static gas mass spectrometer, the method comprising:
receiving, by a volume defined by a source block, a sample gas;
providing, by an electron source in fluid communication with the source block, a flux of electrons therein and ionising the sample gas;
controlling, by a controller, a voltage applied to a set of electrodes, including a first electrode, disposed between the electron source and the source block, comprising:
attenuating, during a first time period following receiving of the sample gas in the source block, the flux of the electrons into the source block by deflecting the flux of electrons away from the source block during the first time period; and
permitting, during a second time period following the first time period, the flux of the electrons into the source block.

15. The method according to claim 14, comprising:
equilibrating, during the first time period following receiving of the sample gas in the source block, the sample gas in the source block.

16. The method according to claim 14, comprising:
determining, by the controller, the first time period.

17. A method of controlling a static gas mass spectrometer, the method comprising:
controlling the ion source according to claim 14; and
detecting, during the second time period following the first time period, the ions from the sample gas.
